(19) United States
(12) Patent Application Publication
(10) Pub. No.: US 2004/0207806 A1
(43) Pub. Date: Oct. 21, 2004

(54) Resilient hinge for a spectacle frame having a dumbbell-shaped pivot pin

(76) Inventor: Alain Kerjean, Saint-Claude (FR)

Correspondence Address: STURM & FIX LLP, 206 SIXTH AVENUE, SUITE 1213, DES MOINES, IA, 50309-4076, US

(21) Appl. No.: 10/843,849

(22) Filed: May 12, 2004

Related U.S. Application Data
(63) Continuation of application No. PCT/IB02/04991, filed on Nov. 25, 2002.

(30) Foreign Application Priority Data
Nov. 29, 2001 (EP) 01420229.5

(51) Int. Cl. G02C 5/22

(52) U.S. Cl. 351/153

(57) ABSTRACT

The invention concerns an elastic hinge for spectacle frame, comprising first and second hinge elements including respectively first and second charniers provided with perforations for receiving a pivot pin when the second charnier is engaged between two faces of the first charnier so as to cause the perforations to be superimposed along a common axial direction countering the compression of a spring housed in one of the hinge elements. The pivot pin comprises two heads and a body integral with both heads to be engaged in translation through the perforations of the charniers until both heads are received in the perforations of the two faces of the first charnier, the body forming relative to both heads a recess to be received in the perforation of the second charnier by offsetting the latter relative to the axial direction of the perforations of the first charnier countering the compression of the spring.

The invention relates to a resilient hinge for a spectacle frame and more particularly to a type of resilient hinge comprising first and second hinge elements possessing respectively a first and second knuckle provided with drillings for receiving a pivot pin when the second knuckle is engaged between two journals of the first knuckle so that the drillings are superimposed in the same axial direction against the compression of a spring housed in one of the two hinge elements.

A hinge of this type is known for example from document EP-A-345 145. The pivot pin has a threaded part to be screwed into a tapping of one of the drillings of the first knuckle. The tapping dictates a minimum thickness of the journal of the knuckle in which the drilling is made. If it is desired, for aesthetic reasons, to reduce this thickness, it becomes necessary to provide bosses to restore locally the minimum thickness imposed by the tapping. These operations bring about machining complications and increase the manufacturing costs. In addition, the operations of screwing and unscrewing the pivot pin can cause scratches to the journal of the first knuckle.

One of the aims of the invention is to overcome these disadvantages.

To this end, the invention concerns a resilient hinge comprising first and second hinge elements possessing respectively a first and second knuckle provided with drillings for receiving a pivot pin when the second knuckle is engaged between the two journals of the first knuckle so that the drillings are superimposed in the same axial direction against the compression of a spring housed in one of the two hinge elements, characterised in that the pivot pin comprises two heads and a body secured to the two heads in order to be engaged in translation through the drillings of the knuckles until the two heads are received in the drillings of the two journals of the first knuckle, the body forming with respect to the two heads a recess to be received in the drilling of the second knuckle while offsetting the latter with respect to the axial direction of the drillings of the first knuckle against the compression of the spring.

The offset of the second knuckle with respect to the axial direction of the drillings of the first knuckle makes it possible to hold the pivot pin between the two journals of the first knuckle. In this way, it is no longer necessary to provide a thread on the pivot pin nor a corresponding tapping on one of the journals of this first knuckle. The pivot pin is simply engaged in translation through the drillings of the superimposed knuckles following the same axial direction, contrary to the case of a threaded pin that has to be screwed into the tapping of the first knuckle.

The pivot pin of a resilient hinge according to the invention is also designated by a dumbbell.

According to a first and advantageous embodiment of a hinge according to the invention, the two journals of the first knuckle are contiguous along a profile inside this knuckle extending from the rear to the front with respect to the axial direction of the drillings in a plane perpendicular to this axial direction. This arrangement makes it possible to stiffen the two journals of the first knuckle with respect to each other all along the inner contiguous profile.

In addition, according to this embodiment, a part of the inner profile extending forwards with respect to the axial direction advantageously forms a stop against which the second knuckle rests when the hinge is opened into a position passing beyond the normal open position.

According to a second advantageous embodiment, the drilling of the second knuckle has a portion with a shape corresponding to the body of the pivot pin. In this way, the contact surface is increased between the body of the pivot pin and the drilling of the second knuckle while contributing to a reduction in the guiding play between the two elements of the hinge.

According to a third advantageous embodiment, the heads of the pivot pin and the drillings of the journals of the first knuckle have corresponding polygonal shapes.

Other advantages of the invention will become apparent on reading the description of an embodiment illustrated by the drawings.

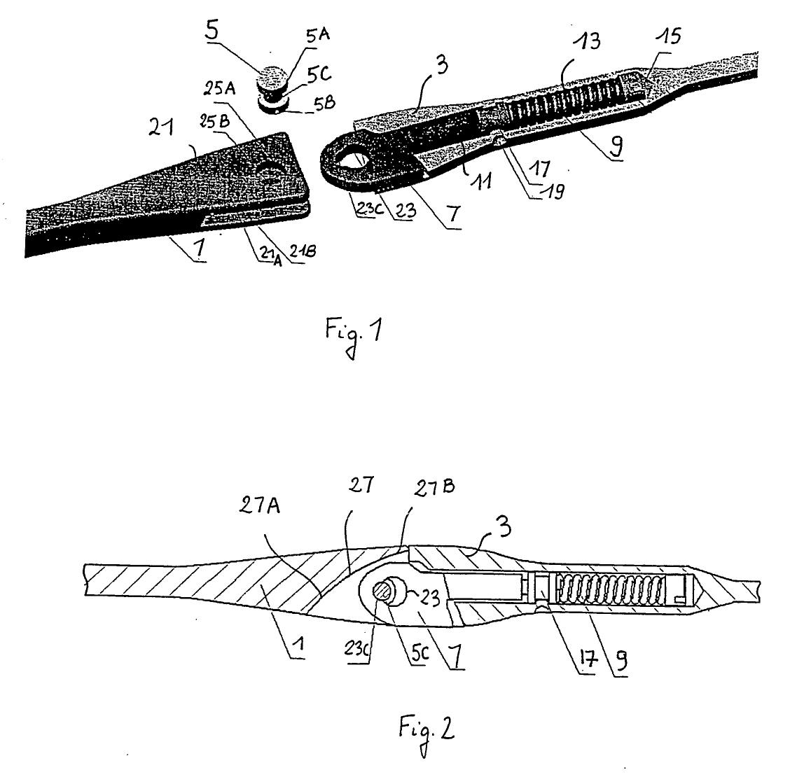

FIG. 1 is an exploded view in partial section of a hinge according to the invention.

FIG. 2 is a sectional view of the hinge illustrated in FIG. 1 in a closed position.

FIG. 3 is a sectional view of the hinge illustrated in FIG. 1 in an open position.

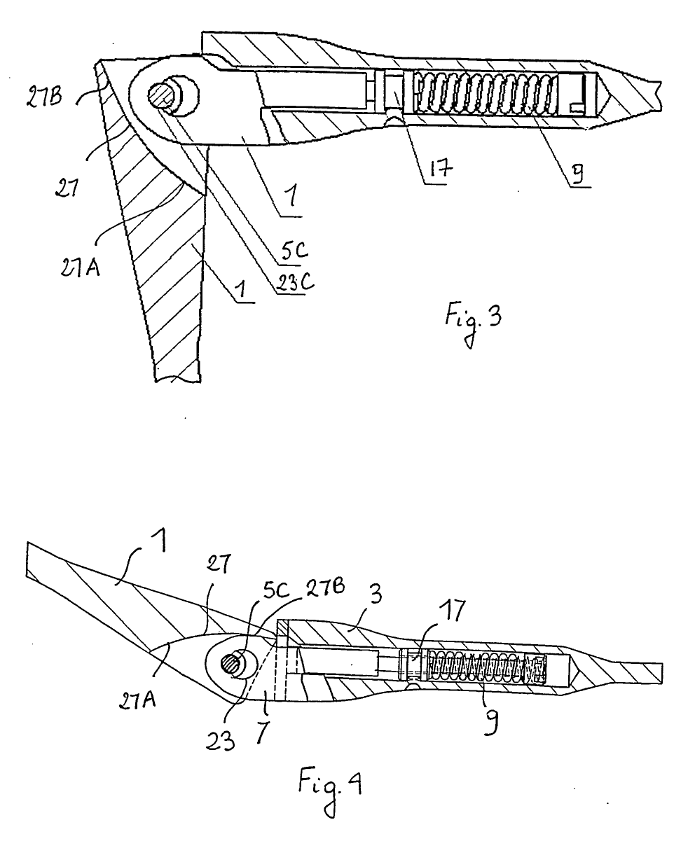

FIG. 4 is a sectional view of the hinge illustrated in FIG. 1 in an over-open position.

With reference to FIGS. 1 to 4, a resilient hinge for a spectacle frame comprises a first 1 and a second 3 hinge element, secured respectively to a lug and an arm of the frame. The first 1 and the second 3 elements possess respectively a first 21 and a second 7 knuckle provided with drillings 23, 25A, 25B for receiving a pivot pin 5 when the second knuckle 7 is engaged between two journals 21A, 21B secured to the first knuckle 21 so as to superimpose the drillings along the same axial direction A against the compression of a spring 9 housed in one 3 of the two hinge elements.

In the particular example chosen to illustrate the invention, the first knuckle 21 is secured to the first hinge element 1 and the second knuckle 7 can move in translation in a housing of the second hinge element 3 against the compression of the spring 9 housed in this element 3. The movable knuckle 7 is secured to a slide 11 belonging to a mechanism comprising a rod 13 about which the spring 9 is positioned. The latter is compressed on the one hand between a stop 15 formed at the end of the rod 13 and a blocking bush 17 positioned at the other end of the rod 13. This blocking bush 17 is immobilised with respect to the hinge element 3, in which the movable knuckle 7 is housed, by a stop 19 obtained for example by crimping.

The two hinge elements 1,3 can move in rotation with respect to each other about the pivot pin 5 distinct from the first and second element. In a known manner, the journals 21A, 21B of the first knuckle 21 are shaped in the form of a cam in order to move the movable knuckle 7 in translation with respect to the hinge element 3 in which it is incorporated against the compression of the spring 9. The result is that the resilient hinge possesses two stable normal open and closed positions in which the two hinge elements 1, 3 are respectively aligned with respect to each other or positioned substantially perpendicularly in relation to each other as illustrated in FIGS. 2 and 3.

According to the invention, the pivot pin 5 comprises two heads 5A, 5B and a body 5C secured to the two heads 5A, 5B so as to be engaged in translation through the drillings 25A, 25B of the first knuckle 21 and the drilling 23 of the second knuckle 7 until the two heads 5A, 5B are received in the drillings 25A, 25B of the first knuckle 21, the body 5C forming with respect to the two heads 5A, 5B a recess to be received in the drilling 23 of the second knuckle 7 while offsetting the latter 7 with respect to the axial direction A of the drillings 25A, 25B of the first knuckle 21 against the compression of the spring 9.

In the embodiment illustrated in FIGS. 1 to 4, the body 5C of the pivot pin 5 possesses a height H slightly greater than the thickness E of the second movable knuckle 7 so as to be received in the drilling 23 of the latter and in this way to enable it to be offset with respect to the axial direction A of the drillings 25A, 25B of the first fixed knuckle 21 against the compression of the spring 9. The drilling 23 of the second knuckle 7 has a portion 23C with a shape corresponding to the body 5C of the pivot pin 5. As can also be seen in the figures, the body 5C of the pivot pin 5 and the portion 23C with a shape corresponding to the second knuckle 7 have a circular shape. The heads 5A, 5B of the pivot pin 5 and the drillings 25A, 25B of the journals 21A, 21B of the first knuckle 21 also have corresponding circular shapes. In this arrangement, the recess D is defined by the difference in diameters of the circular shapes of the bodies and heads. In addition, the heads 5A, 5B of the pivot pin 5 are identical as well as the drillings 25A, 25B of the first knuckle. In this way, the pivot pin can be engaged in translation in one orientation or in the opposite orientation along the same axial direction of the drillings of the two knuckles.

With reference more particularly to FIGS. 2 to 4, the two journals 21A, 21B of the first knuckle 21 are contiguous along a profile 27 inside this knuckle extending from the rear 27A to the front 27B with respect to the axial direction A of the drillings 25A, 25B in a plane perpendicular to this axial direction A. The two journals 25A, 25B are for example milled in the thickness of the first knuckle 21 so as to form the contiguous inner profile 27. This arrangement makes it possible to stiffen the two journals 21A, 21B of the first knuckle 21 with respect to each other all along the inner profile 27.

In addition, a part of the inner profile 27 extending forwards with respect to the axial direction A forms a stop 27B against which the second knuckle 7 rests when the hinge is opened into an over-open position, that is to say beyond the normal open position, as illustrated in FIG. 4. This arrangement makes it possible to prevent excessive stresses on the rod 13 of the resilient return mechanism of the hinge illustrated in the figures. The resistance in over-opening is no longer provided by the rod itself but by the second knuckle 7 butted up against the front part 27B of the inner profile 27 formed at the junction between the two journals 21A, 21B of the first knuckle 21.

The heads 5A, 5B of the pivot pin 5 and the drillings 25A, 25B of the journals 21A, 21B of the first knuckle 21 are designed with corresponding polygonal, star-shaped or splined forms. In addition, one of the two heads of the pivot pin as well as the journal of the first knuckle in which it is received can have a different shape with respect to the other head and the other corresponding journal.

In a resilient hinge according to the invention, in the example of an embodiment illustrated in FIGS. 1 to 4, the pivot pin brings about an assembly of the two hinge elements while being retained between the two elements without requiring a thread or a tapping in one of the drillings of the first knuckle. This arrangement makes it possible to reduce the minimum thickness of the journals of this knuckle with respect to a pivot pin. The absence of a tapping makes it possible for the pivot pin, the lug and the arm of the frame to be parts manufactured in different plastic, metallic, or ceramic materials for example, and to be produced according to different manufacturing techniques such as for example injection, sintering, cutting and folding. It is also possible for the pivot pin to be manufactured by injection moulding with a metal powder. Finally, the simplicity of machining limits the number of repeat machinings.

1. Resilient hinge for a spectacle frame, comprising a first and second hinge element possessing respectively a first and second knuckle provided with drillings for receiving a pivot pin when the second knuckle is engaged between the two journals of the first knuckle so that the drillings are superimposed in the same axial direction against the compression of a spring housed in one of the two elements of the hinge, wherein the pivot pin comprises two heads and a body secured to the two heads in order to be engaged in translation through the drillings of the knuckles until the two heads are received in the drillings of the two journals of the first knuckle, the body forming with respect to the two heads a recess to be received in the drilling of the second hinge while offsetting the latter with respect to the axial direction of the drillings of the first knuckle against the compression of the spring.

2. Resilient hinge according to claim 1, wherein the two journals of the first knuckle are contiguous along a profile inside this knuckle extending from the rear to the front with respect to the axial direction of the drillings in a plane perpendicular to this axial direction.

3. Hinge according to claim 2, wherein a part of the inner profile extending forwards with respect to the axial direction forms a stop against which the second knuckle rests when the hinge is opened into a position passing beyond the normal open position.

4. Hinge according to claim 1, wherein the drilling of the second knuckle has a portion with a shape corresponding to the body of the pivot pin.

5. Hinge according to claim 4, wherein the body of the pivot pin and the portion with a shape corresponding to the second knuckle have a circular shape.

6. Hinge according to claim 1, wherein the heads of the pivot pin and the drillings of the journals of the first knuckle have corresponding polygonal, star-shaped or splined shapes.
